(19) United States
(12) Patent Application Publication
(10) Pub. No.: US 2012/0171325 A1
(43) Pub. Date: Jul. 5, 2012

(54) METHOD FOR THE PRODUCTION OF A GUM BASE

(75) Inventors: Elke Arendt, Co. Cork (IE); Liam Ryan, Co. Tipperary (IE)

(73) Assignee: UNIVERSITY COLLEGE CORK, NATIONAL UNIVERSITY OF IRELAND CORK, Cork (IE)

(21) Appl. No.: 13/379,686

(22) PCT Filed: Jul. 2, 2010
(86) PCT No.: PCT/EP2010/059493

§ 371 Date: Mar. 21, 2012

Related U.S. Application Data
(60) Provisional application No. 61/222,520, filed on Jul. 2, 2009.

(30) Foreign Application Priority Data
Jul. 2, 2009 (EP) 09164443.5
Apr. 30, 2010 (EP) 10161695.1

(51) Int. Cl. A23G 4/14; A23G 4/08

(52) U.S. Cl. 426/3

(57) ABSTRACT

A method for the preparation of a gum base or chewable entity comprises the step of treating a mixture comprising cereal protein, for example gluten, and water, optionally in combination with sugar, sugar substitute or other functional ingredient, at a hydrostatic pressure of at least 100 MPa for at least 2 mins. Generally, the mixture is pressure treated at an elevated pressure of at least 25° C. The temperature, pressure and treatment time may be varied provided that the combination of the three results in the modification of the viscoelastic properties of the mixture to resemble that of conventional chewing gum. The treatment time of the current invention is inversely related to the hydrostatic pressure and temperature of the treatment. Thus, if the pressure and/or the temperature are increased, the treatment time may be reduced.

### FIELD OF THE INVENTION

The current invention relates to a gum base or chewable entity. More specifically the current invention relates to a method for the production of a multifunctional gum base. The gum base and/or chewing gum produced by the method of the current invention is biodegradable and digestible as well as applicable for use as a carrier for medicinal, therapeutic and nutritive agents.

### BACKGROUND TO THE INVENTION

Chewing gum is a type of confection prepared for chewing. In general, chewing gum is composed of a gum base mixed together with sugars and other flavourings. Upon chewing, the gum base releases the flavours into the mouth of the consumer over a short period of time. Chewing gum is not usually swallowed by the consumer and does not dissolve in the mouth of consumer. The gum base utilised in the preparation of a chewing gum is traditionally made of chicle, a natural latex product, or polyisobutylene. Chicle is a natural gum from the Manilkara chiclecle tree. Polyiosbutylene is a synthetic rubber or elastomer, often used for inner tubes or to line tubeless tyres. It is a non-vulcanisable form of butyl rubber (isoprene-isobutylene). Modern chewing gums however, are generally composed of rubber instead of chicle. Chewing gum can also contain additional ingredients serving to modify the appearance and taste of the gum. These include sweeteners, flavours or colourants. While chewing gum was historically sweetened with cane sugar, xylitol, corn syrup or other natural sweeteners, a large number of brands now use artificial sweeteners such as aspartame, sucralose, or acesulfame potassium. Non-coated varieties of gum are often covered in sweetened marble dust to prevent the wrapper from sticking to the product.

The manufacturing methods of chewing gum are reasonably consistent between brands. Customarily, the gum base is melted at a temperature of about 115° C. (240° F.), until it has the viscosity of thick maple syrup. It is subsequently filtered through a fine mesh screen, after which it is further refined by separating dissolved particles in a centrifuge, and further filtered. The resulting clear base, still hot and melted, is then put into mixing vats. Other ingredients that may be added at this point include: powdered sugar (the amount and grain size of which determines the brittleness of the resulting gum), corn syrup and/or glucose (which serve as humectants and coat the sugar particles to stabilize their suspension and keep the gum flexible), various softeners, food colourings, flavourings, preservatives and other additives. The homogenized mixture is then poured onto cooling belts and cooled with cold air. Extrusion, optional rolling and cutting, and other mechanical shaping operations follow. The chunks of chewing gum are then allowed to set for 24 to 48 hours.

Coated chewing gums undergo additional operations. The chunks of chewing gum are wrapped with optional undercoating. This provides better binding with the outer layers. The chunks of chewing gum then are immersed into liquid sugar. Following this they undergo colouring and coating with a suitable glazing agent, usually a wax. The coating/glazing/colour on the chewing gum is derived from animal-based sources such as resinous glaze derived from an insect or beeswax. Conventional chewing gums are however, associated with several drawbacks. The bases utilised in the manufacture of conventional chewing gum, such as those mentioned in previous paragraphs, are not readily biodegradable, or digestible. The disposal of conventional chewing gums can therefore cause unsightly litter and waste. As chewing gum is also very sticky the waste produced can be extremely difficult to remove. These characteristics have led to the emergence of many environmental concerns surrounding the use of chewing gum. Numerous reports have been published stating that up to 25% of all discarded food waste is chewing gum and related products. This in turn places a significant financial burden and responsibility on local authorities and environmental agencies. In order to combat these issues, a number of educational institutions worldwide have banned the sale of chewing gum on campus. Singapore took extreme action when it introduced a chewing gum ban in 1992, which banned the import and sale of chewing gum in Singapore. Following its revision in 2004, the ban was lifted on the sale of chewing gum of “therapeutic” value. Not surprisingly, these actions have resulted in significant financial loss for chewing gum producers.

Apart from the significant environmental issues, there are also concerns associated with the sustainability of chewing gum ingredients. The methods of collecting and processing both chicle and polyiosbutylene are extremely labour intensive as well as highly inefficient and results in the use of potential agricultural land in Latin America. Many chewing gum ingredients are also sourced from politically volatile areas and constant supply is not always guaranteed. The U.S. Department of Labour has released a number of reports stating that latex allergy is commonplace with up to 100 complaints being received during 1988-1992. There were also 15 deaths reportedly due to latex exposure. These reports initiated obvious health concerns over the use of chewing gum. Along side these concerns are reports that some of the chemicals used in the manufacturing process of chewing gum are also quite dangerous, causing negative side effects.

In an attempt to overcome these issues chewing gum has been developed in which cereal proteins e.g. gluten from wheat is utilised for the production of a gum base or chewable composition. Gluten is a waste product from the production of wheat starch, a commonly used food ingredient and thus widely available. In addition, gluten has the added benefit of being an edible natural food product, a property which in itself surmounts the recent health concerns surrounding conventional chewing gums. Chewable compositions, in which gluten is used as an alternative base, together with methods of manufacture, have been disclosed in the literature. JP9047226 discloses the development of a type of confectionery the gum base of which consists of gliadin derived from wheat gluten. WO9417673 discloses a biodegradable chewing gum comprising wheat gluten and a texturising agent such as calcium carbonate. WO02/041701 describes a chewable composition containing gluten, sugar and water. The process for the preparation of the same involves kneading the mixture of gluten, sugar and water, until the gluten molecules have undergone a degree of unravelling. The following kneading conditions are employed: (a) temperature: 50-80° C. (b) shear or kneading energy: 50-80 kJ. Preferably, the kneading time used is 5-50 mins.

The inventors of U.S. Pat. No. 6,818,245 and EP1066759 describe the production of a digestible gluten basic composition, which can be utilized as a gum base for chewing gums. The described method in which chewing gum like products are prepared involves mixing wheat gluten with a non-aqueous medium that contains less than 20% water, kneading the mixture obtained at a temp between 50 and 90 degrees until at least 75% of the max torsion is achieved. U.S. Pat. No. 6,106,881 describes the process for the preparation of an edible chewing gum containing gluten. The aim of U.S. Pat. No. 6,106,881 was to provide a process for an edible chewing gum having such an elasticity and extensibility similar to that of chewing gum of the prior art. The process disclosed involves thermally treating the gliadin rich fraction of wheat gluten in a water containing states in pH 4 to 11. This step serves to denature the gliadin. This is then mixed with a protein transferase to crosslink the proteins. The inventors of WO9512322 developed a non-adhesive chewing gum base comprising a gluten component and a protein-condensing agent. This agent serves to promote cross-linking among the gluten proteins.

Despite these advancements, the development of an accepted gluten-based gum has proven difficult. Current gluten based gums do not display the required or desirable organoleptic or functional properties.

It is an object of the invention to overcome at least one of the above problems.

### STATEMENTS OF INVENTION

The current inventors have used gluten in combination with a novel processing technique to produce a gum base or chewable entity with organoleptic and functional properties similar or superior to those of commercially available conventional gum products. Moreover, the gum base of the current invention is advantageous over commercially available products and does not boast the shortcomings of current gluten based gums. The gum base is biodegradable and digestible and comprises cheap, readily available and sustainable ingredients. An added benefit is that the gum base is not sticky allowing easy handling during the production process. Unlike other gum alternatives the initial energy (chewing required) to make the product workable (chewy) is very little and the chewiness is reasonably constant throughout the chewing period.

Accordingly, there is provided a method for the preparation of a gum base or chewable entity, the method comprising the step of treating a mixture comprising cereal protein and water, optionally in combination with sugar, sugar substitute or other functional ingredient, at a hydrostatic pressure of at least 100 MPa for at least 2 mins.

The effect of pressure, or preferably, pressure and heat, causes an increased degree of denaturation of the gluten molecules, and an increased degree of gluten/water interaction, while maintaining the gluten in a stable form. This treatment has been found to produce a gum having viscoelastic properties similar or superior to conventional gums.

The temperature, pressure and treatment time may be varied provided that the combination of the three results in the modification of the viscoelastic properties of the mixture to resemble that of conventional chewing gum. The treatment time of the current invention is inversely related to the hydrostatic pressure and temperature of the treatment. Thus, if the pressure and/or the temperature are increased, the treatment time may be reduced. Likewise, if the pressure and/or temperature are decreased, the treatment time may be increased. Also, if the pressure is sufficiently high, elevated temperature is not required and the process may be carried out at room temperature. However, in a preferred embodiment, the process is carried out at an elevated temperature, typically at least 25° C.

Typically, the process involves an initial step of mixing the components of the mixture to provide a homogenous mixture.

Typically, the method of the invention comprises a further heating or drying stage after the pressure treatment. Suitably, the mixture is heated at between 60° C. and 180° C., typically at between 90° C. and 150° C., preferably at between 120° C. and 140° C., for between 5 seconds and 90 seconds, typically for between 10 and 60 seconds, and ideally for between 20 and 40 seconds. Alternatively, the mixture is dried at a lower temperature but for a longer time, for example 60° C. for 24 hours. The treatment time and treatment temperature are inversely proportional; thus, as the treatment time is decreased, the treatment temperature may be increased, and vice versa.

In a preferred embodiment, the pressure may be between 100 and 3000 MPa, suitably 100 to 2500 MPa, typically between 200 and 800 MPa, suitably between 300 and 700 MPa, suitably between 350 and 650 MPa, preferably between 400 and 600 MPa, and more preferably between 450 and 550 Mpa. Ideally, the pressure is between 480 and 520 MPa.

In one embodiment, the pressure is between 100-200 MPa, 200-300 MPa, 300-400 MPa, 400-500 MPa, 500-600 MPa, 600-700 MPa, 700-800 MPa, 800-900 MPa, 900-1000 MPa, 1000-1100 MPa, 1100-1200 MPa, 1200-1300 MPa, 1300-1400 MPa, 1400-1500 MPa, and 1000-3000 MPa. A skilled person in the art will appreciate that the pressure may be at any MPa within these ranges. In one preferred embodiment the pressure is 500 MPa.

The temperature is typically between 25° C. and 200° C., suitably between 30° C. and 150° C., typically between 35° C. and 100° C., preferably between 40° C. and 80° C., more preferably between 50° C. and 70° C., and ideally about 60° C. The temperature may be between 20-30, 30-40, 40-50, 50-60, 60-70, 70-80, 80-90, 90-100, 100-110, 110-120, 120-130, 130-140, 140-150, 150-160, 160-170, 170-180, 180-190, 190-200° C. It will be appreciated that, in one embodiment, elevated temperature is not required.

The treatment time is typically between 2 mins and 36 hours, suitably 2 mins to 24 hours, typically 2 mins to 20 hours, suitably between 2 mins and 2 hours, typically between 2 mins and 60 mins, preferably between 4 mins and 30 mins, more preferably between 6 mins and 15 mins, and ideally between 8 mins and 12 mins.

In embodiments in which a sugar (or sugar substitute) is employed, the cereal protein:sugar (or sugar substitute) ratio is suitably from 5:10 to 10:5, typically from 8:10 to 10:8 (w/w). Ideally it is about 1:1 (w/w). However this ratio can be varied on the addition of other functional or therapeutic agents to maintain the viscoelastic properties.

The sugar:water ratio is suitably 1:1.5 to 1:4 (w/v), typically from 1:1 to 1:4, and preferably from about 1:15 to about 1:3.5 (w/v). However this ratio can be varied on the addition of other functional or therapeutic agents to maintain the viscoelastic properties

The cereal protein:sugar:water ratio can vary significantly. In a preferred embodiment the cereal protein:sugar:water ratio may be 1:1:1 to 1:1:4, suitably from 1:1:1 to 1:1:3 (w/w/v). However this ratio can be varied on the addition of other functional or therapeutic agents to maintain the viscoelastic properties

Thus, in one preferred embodiment of the invention, the mixture comprises:

10-35% cereal protein;

10-35% sugar; and

30-80% water (w/w/v).

In another embodiment of the invention, the mixture comprises:

15-25% cereal protein;

15-25% sugar; and

50-70% water (w/w/v).

In a preferred embodiment of the invention, the mixture comprises:

20-30% cereal protein (especially gluten);

20-30% sugar; and

40-60% water (w/w/v).

In a preferred embodiment of the invention, the mixture comprises:

about 25% gluten;

about 25% sugar, especially fructose; and

about 50% water (w/w/v).

The term “about” as employed above should be understood to mean+/−10%.

In another embodiment, the mixture contains no sugar or sugar substitute, and suitably consists essentially of cereal protein, for example gluten, and a solvent, suitably an aqueous solvent such as water, for example 1-99% water and 1-99% gluten, more preferably 20-80% gluten and 20-80% water, more preferably 30-70% gluten and 30-70% water (w/w). Thus, the gum base may be made in the complete absence of sugar, or indeed a sugar substitute or other functional ingredient.

In a preferred embodiment of the current invention, the mixture is treated for a given time at a given hydrostatic pressure at a given temperature, with the synergistic activity of all these parameters causing the resultant change in the viscoelastic properties of the treated ingredient combination. In a still preferred embodiment, the starting mixture of the present invention is treated for 10 min at a pressure of 500 MPa and at a temperature 60° C.

In a preferred embodiment of the current invention the cereal protein is gluten (protein derived from wheat cereal). However, the cereal protein may be derived from other cereals or pseudocereals for example, rye, barley, pea, rice, maize or sorghum, teff and buckwheat or any combination thereof, or from flour derived from these cereals or their combinations. Gluten is generally isolated from wheat flour. Ideally, the gluten is vital gluten.

Suitably, the sugar can be any sugar. Examples of suitable sugars are fructose, sucrose, glucose, maltose, lactose, and galactose, or derivatives thereof. Sugar substitutes will be well known in the art and include sugar alcohols such as sorbitol and mannitol, sweet syrups e.g. corn or maple syrup, sugar alcohols such as glycerol, sorbitol and mannitol, or derivatives thereof, and artificial sweeteners such as aspartame and saccharine. Functional ingredients suitable for modifying the functional characteristics of foods will be well known to those skilled in the art, and include viscosity modifying agents, for example hydrocolloids such as xanthan, guar and pectin, cellulose or carrageenan or derivatives thereof, organic acids such as citric acid, or phenol containing acids such as tannic acid and gallic acid, phenyllactic acid as well as this any plasticisers or plastifying material e.g. glycerol. It will be appreciated that sugar, sugar substitutes, or functional ingredients are not required to achieve the gum base or chewable entity of the present invention, and that the only essential components are a cereal protein and water which are heat and pressure treated over a suitable period of time. However, it has been found that superior viscoelastic and organoleptic properties can be achieved when additional components, such as a sugar or sugar substitute, are employed.

The gum base is typically biodegradable and/or edible as well as being capable of being digested in the intestine. This means that the gum base or chewable entity is susceptible to degradation by proteases commonly found in the mammalian digestive tract.

The invention also relates to a gum base or chewable entity obtainable by the method of the invention.

The invention also relates to a chewable product or entity comprising the gum base obtainable by the method of the invention. The chewable product is selected from the group consisting of: chewing gum; confectionary gums (e.g. wine gums); and pharmaceutical, therapeutic or medicinal gums (e.g. vitamin-, medicine- or nicotine-containing gums). The invention also relates to a chewable product for use with geriatrics, for example a chewable comestible product including an active ingredient such as, for example, a pharmaceutical, a neutrical, or a nutritional component.

The invention also relates to the use of the gum base of the invention in the manufacture of films, especially edible films.

In a further aspect the current invention provides an elastic material or textured food product comprising a gum base or functional ingredient obtainable by the method of the current invention.

The invention also provides a gum base or chewable entity comprising pressure treated cereal protein and water. The term “pressure treated” as applied to cereal protein means that the cereal protein in the gum base or chewable entity has a modified cereal protein network that provides comparable or improved viscoelastic properties compared to conventional gums, and is caused by treating the cereal protein at a hydrostatic pressure of at least 100 MPa for at least 2 mins.

Ideally, the cereal protein is heat and pressure treated. This means that the pressure treatment is carried out at elevated pressure, ideally at least 25° C.

Typically, the cereal protein is gluten.

Suitably, the gum base or chewable entity is typically biodegradable and digestible. Ideally, the gum base or chewable entity is not sticky, and will not adhere to a surface when discarded (in contrast to conventional chewing gums).

In one embodiment, the gum base or chewable entity has a break point of at least 600 Pa, 800 Pa, 1000 Pa, 1200 Pa, 1400 Pa, 1500 Pa, 1700 Pa, 1900 Pa, 2100 Pa, 2300 Pa. The break point is the maximum force required to cause irreversible damage to the structure of the gum product/chewable entity, and is measured in Pascals. A method for determining the break point in Pascals is described in detail below.

Typically, the gum base or chewable entity has a complex modulus at 0.01% strain of at least 100,000 Pa, 500,000 Pa, 1,000,000 Pa, 1,500,000 Pa, 2,000,000 Pa, or 3,000,000 Pa. The complex modulus is the resistance to deformation (to an applied force), and is measured in Pascals. A method for determining the complex modulus in Pascals is described in detail below.

In a preferred embodiment, the gum base or chewable entity comprises a sugar or sugar substitute. Examples of suitable sugars or sugar substitutes are provided above.

### BRIEF DESCRIPTION OF THE DRAWINGS

The current invention will now be described with reference to the following examples and figures. It is to be understood that the following detailed description and accompanying figures, are exemplary and explanatory only and are intended to provide a further explanation of the present invention, as claimed and not to limit the scope of the invention in any way.

FIG. 1: Elasticity of the gum base produced using fructose and 200% water as well as gluten, it can clearly be seen that this is an extremely stretchy product and is structurally strong.

FIG. 2: Elasticity and tear resistance of the gum base produced. It can clearly be seen that the gum base is structurally strong as well as quite tear resistant.

FIG. 3: Bubble blowing ability of the gum base evaluated using a texture profile analyser. It can clearly be seen that the gum base can withstand significant pressure and is capable of supporting bubble blowing. This test is based on blowing air from below under pressure through a dough and checking the gas holding capacity.

FIG. 4: Graph plotting the Amplitude sweep of a number of gum samples, namely chicle (▪), Wrigleys chewing gum (▴), Orbit chewing gum (x), and the gum base of Example B of the invention (*).

FIG. 5: Graph plotting the strain sweep of a number of gum samples, namely chicle (▪), Wrigleys chewing gum (▴), Orbit chewing gum (x), and a gum base of Example B of the invention (*).

FIG. 6: Graph plotting the Complex Modulus (G*Pa) versus Strain (%) for a number of gums, namely water and gluten mixture (no heat) (▪), heat treated (90 C˜18 h) gluten, sugar and water mixture (1:1:2 w/w/v) (▴), and a gum base according to Example B the invention (♦).

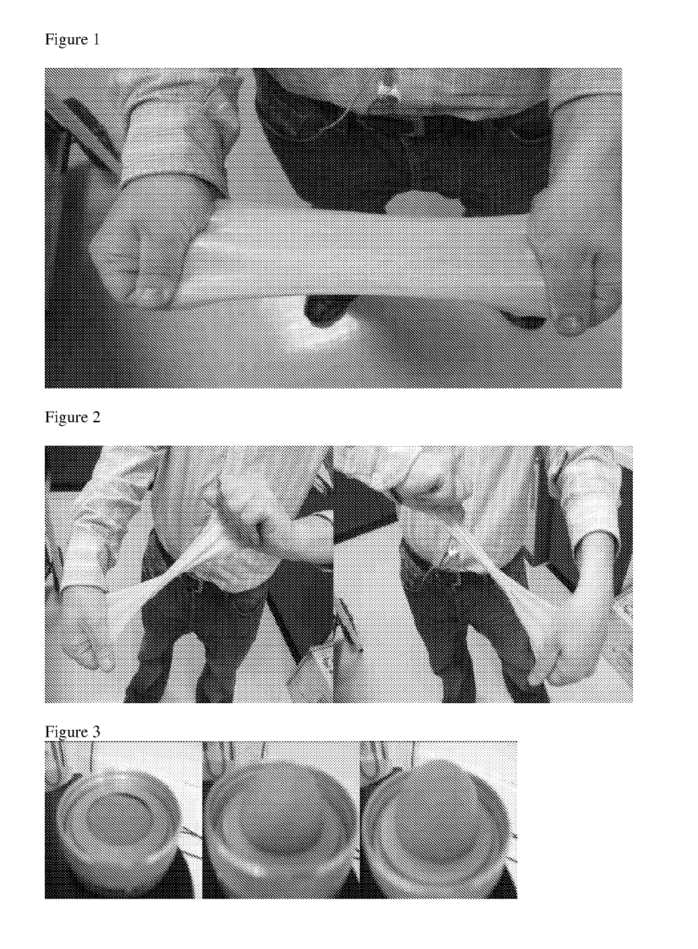

### DETAILED DESCRIPTION OF THE DRAWINGS

### Material and Methods

### Production of Gum Base

### Example A

100 g of vital gluten (Sigma Aldrich, Germany) was mixed with 100 g of fructose (Sigma Aldrich, Germany). 200 g of water was then added and the product was mixed for 2 min at speed 2 using a Kenwood mixer. This mixture was then placed in a vacuum pack bag and seal under vacuum. This step was repeated twice to ensure no leaking of product during treatment. This was then placed in an ISO-LAB 900 High Pressure Processing Unit (Stansted, UK) and treated for 10 minutes at 500 MPa and 60° C. After treatment the sample was removed from the bags and treated at 130° C. for 30 sec. The products functional properties were then evaluated.

### Production of Alternative Gum Base

### Example B

As for Example A, except for:

Dried at 60° C. for 18 hours

### Production of Alternative Gum Bases

### Examples C and D

As for Example A, except for:

Gluten and water are mixed 50:50 (w/v—Example C) and 30:70 (w/v—Example D)
The mixture is then packaged for high pressure treatment
Treated for 10 minutes at 500 MPa and 60° C.
Removed from Machine

### Dried at 60° C. for up to 24 hrs

### Production of Alternative Gum Base

### Example E

As for Example A, except for:

Treated for 5 minutes at 800 MPa and 60° C.

### Production of Alternative Gum Base

### Example F

As for Example A, except for:

Treated for 20 minutes at 300 MPa and 60° C.

### Production of Alternative Gum Base

### Example G

As for Example A, except for:

Treated for 20 minutes at 1500 MPa and 25° C.

### Conversion of Gum Base to Chewing Gum

The gum base produced in this study is capable of being used in a standard gum production set up. To convert it to a workable chewing gum the gum base of the invention treatment may include extrusion, optional rolling and cutting, and other mechanical shaping operations follow. The chunks of chewing gum are then allowed to set for 1 to 48 hours. At any stage throughout the initial treatment i.e. mixing to the final cutting and shaping step flavouring, texturising or other functional ingredients can be added.

The production of coated chewing gums would require additional operations. The chunks of chewing gum would be wrapped with a functional undercoating that provides better binding with the outer layers. The chunks of chewing gum then are immersed into liquid sugar. Following this they undergo colorings and coating with a suitable glazing agent, usually a wax. The coating/glazing/color on the chewing gum is derived from animal-based sources such as resinous glaze derived from an insect or beeswax.

### Selection of Modifying Technology

A number of techniques were used to modify the viscoelastic properties of gluten. The conditions are outlined in Table 1. These included using different temperatures (60-200° C.) over various times (0.25-24 h), high pressure (200-1500 MPa) and a combination of intermediate to high temperature (60-200° C.). The results of this study show that pressure is required to modify gluten properties to be similar or superior to those of conventional gums.

TABLE 1
The effect of temperature and pressure on the viscoelastic
properties of gluten

| Temperature (° C.) | Pressure (MPa) | Time Result |
|---|---|---|
| 60 | 500 | 5 min Good |
| 60 | 500 | 10 min Excellent |

### Selection of Optimal Water Level

All the ingredients utilised to modify the functional properties of modified gluten are shown in Table 2. All these tests were performed at 100% to 350% water addition levels and the samples were treated using 500 MPa in combination with 60° C. for 10 min. All ingredients were added at the levels stated in the table and the water level chosen as optimal was based on the viscoelastic properties observed. The results in Table 2 indicate that the promise of the invention can be achieved using different water levels and with different sugars.

TABLE 2
Ingredients used to modify the functional properties of modified gluten.

| Ingredient | Water level (%) | Result |
|---|---|---|
| Fructose* | 200 | Optimum |
| 100% | 250 | Good |
| | 300 | Good |
| | 350 | Good |
| Sucrose | 200 | Good |
| 100% | 250 | Optimum |
| | 300 | Good |
| | 350 | Good |
| Glucose | 200 | Good |
| 100% | 250 | Optimum |
| | 300 | Good |
| | 350 | Good |
| Galactose | 250 | Optimum |
| 100% | | |

### Selection of Level of Functional Ingredient Addition

Once the optimal water level for the modification of gluten was found for all ingredients in Table 2, the current inventors optimised the ingredient level to ensure that the optimum level of modification occurred, while also including the maximum amount of water to ensure maximum profitability and commercial acceptability (Table 3). The water level utilised was the optimum found for each compound based on the required viscoelastic properties.

TABLE 3
Effect of the addition of various ingredients on the viscoelastic
properties of gluten, to produce a chewing gum like product.
Anything labelled Pass had the required effect on the
viscoelastic properties of the treated gluten.
(Fructose was the best).

| Additive utilised | Level of addition (%) fwb | Result |
|---|---|---|
| Fructose | 100 | Pass |
| Sucrose | 100 | Pass |
| Glucose | 100 | Pass |
| Galactose | 100 | Pass |

### Evaluation of the Gums

Each gum was evaluated for acceptability, by stretching the gum to ensure elasticity as well as structural strength comparable to that of commercial gum. Each gum which was deemed satisfactory was then evaluated further organoleptically with respect to chewability, strength as well as taste.

### Oscillartory Tests: Amplitude Sweep

During an amplitude sweep the amplitude of the deformation—or alternatively the amplitude of the shear stress—is varied while the frequency is kept constant. The amplitude is the maximum of the oscillatory motion. For the analysis the storage modulus G′ and the loss modulus G″ are plotted against the deformation. The moduli in the linear-viscoelastic region at low deformation characterize the structure in peace of the sample.

At low deformation G′ and G″ are constant; the sample structure is undisturbed. This region is called linear-viscoelastic (LVE). As soon as the moduli start to decrease, the structure is disturbed, viz. the end of the LVE-region is reached: the plateau value of G′ in the LVE-region describes the rigidity of the sample at rest; the plateau value G″ is a measure for the viscosity of the unsheared sample. The ratio of the two moduli gives information about the characteristic of the sample: If the storage modulus is larger than the loss modulus the sample behaves more like a viscoelastic solid. In the opposite case—G″>G′ in the LVE-region—the sample has the properties of a viscoelastic fluid. As such, the larger the difference between the moduli, the more the samples show the properties of a pure fluid and solid, respectively. The amplitude sweep and also the yield point can be determined. Therefore two special points can be used: the end of the LVE-region and the intersection of the curves for G′ and G″. In most cases the intersection of G′ and G″ is of more practical importance.

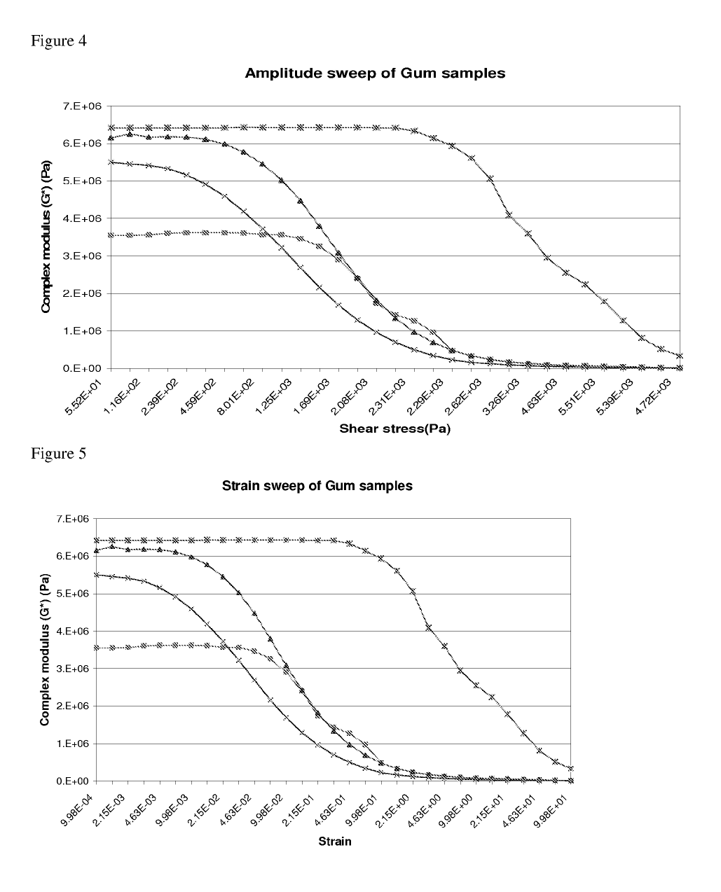

In this study a number of different parameters and gum varieties were performed. In FIGS. 4 and 5 and Table 6, the viscoelastic properties of a gum base formed according to Example B was compared with

Chicle—a key ingredient in some chewing gums

Wrigley stick gum (unchewed)

Orbit complete (coated gum piece unchewed)

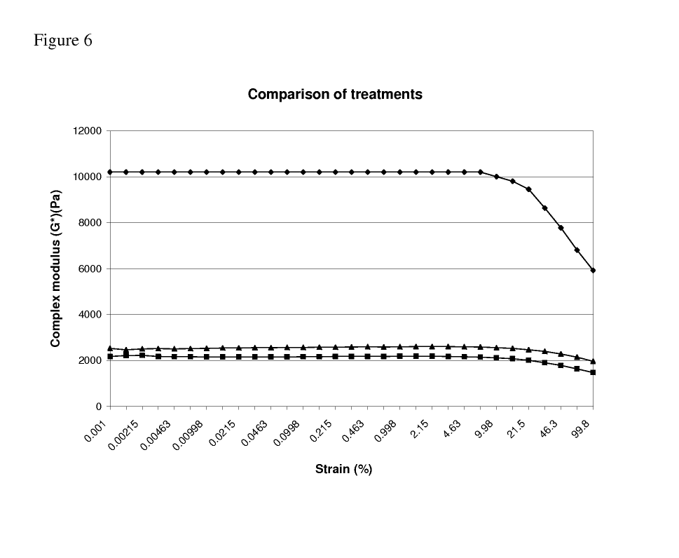

In FIG. 6 and Table 7, various parameters for the production of a gum base were compared with reference to three different gum bases, namely water and gluten, treated gluten and sugar mixture, and a gum base according to the invention.

### Biodegradability/Digestability Tests

This gum base was evaluated for its ability to biodegrade in both model and environmental systems.

Model System: The gum base was chewed for 10 min and then exposed to the environment for 10 minutes. This was then packed in plastic bags and heat sealed, two sterile tips were placed in the bag to ensure a stable environment. This was also compared to an unchewed gum base sample

Environmental evaluation: The Gum base was chewed and placed outside in a number of locations exposed to the environment.

Protease treatment: At present a number of detergents used in household and street cleaning applications contain the enzyme protease—due to the proteinaceous nature of the gum base utilised it was decided to evaluate the effect of protease treatment on the biodegradability of the gum. In this study the samples were treated as for the model system, however 0.1 mL of a 0.01% protease solution was sprayed onto the surface prior to packing.

### Results

### Selection of the Technology

The selections of the technology as well as the optimisation of the parameters for treatment are shown in Table 1. It was also found that temperature alone (90° C.) required up to 24 h to alter the properties of the gluten sufficiently (the final product however was still very poor quality and nothing like chewing gum). The following experiments were performed using 50 g of gluten in combination with 100 mL of water and the effect on the viscoelastic properties were examined as described previously. The results of this study clearly show that both pressure and temperature are required to modify gluten properties.

### Selection of Functional Ingredients

The aim of this section was to evaluate common ingredients for their ability to positively affect the viscoelastic properties of treated gluten (Table 3). Table 4 shows the optimum addition level for each ingredient added. The following experiments were performed at a water addition level of 200% based on gluten level used and were treated for 10 min and 500 MPa and 60° C. It was found that sugar was the optimal additive to modify the rheological properties of treated gluten. Fructose was however the best of all the sugars tested. This was extremely advantageous as the addition of sugars adds sweetness to an otherwise bland product. It is also beneficial as sugar is an extremely common and widely accepted food additive.

TABLE 4
Optimal addition level for each additive

| Additive | Optimal % addition level* |
|---|---|
| Fructose | 100 |
| Sucrose | 100 |
| Glucose | 100 |
| Maltose | 100 |
| Lactose | 100 |
| Galactose | 100 |
| Cysteine | 1 |
| Glycerol | 50 |
| Citric acid | 50 |
| Tannic acid | 10 |
| Gallic acid | 10 |

*Optimal under these chosen conditions

*Optimal under these chosen conditions

### Optimization of Water Level

Water level has a dramatic effect on the viscoelastic properties of high-pressure treated samples. The level of water added is also critical from an industrial point of view as maximizing the level of water added is of critical importance with respect to product cost. Each ingredient was added at its optimum level as previously determined. It was found above that the optimum level of water addition was 200% in combination with fructose and treated for 10 min at 500 MPa at 60° C. However, the results also indicated that water levels less than, and greater than, 200% provided acceptable results.

The final optimised recipe for the gum base 400 g

Table 5 outlines the final optimised recipe developed by the inventors.

TABLE 5
The final optimised recipe for the gum base (400 g)

| Ingredient** | Weight (g) |
|---|---|
| Gluten | 100 |
| Fructose | 100 |
| Water | 200 |

Conditions 10 min - 500 Mpa - 60° C. - 22c per kilo*
*Estimated based on industrial scale production at a reasonable throughput (Information supplied by Stansted High Pressure Systems)
**Optimal levels under given treatment conditions

### Viscoelastic Properties

TABLE 6
Table of maximum force required to cause irreversible damage
to the structure of the gum product/gum bases

| | Force table | | | |
|---|---|---|---|---|
| | Chicle | Wrigleys | Orbit | UCC Gum base |
| Break point (Pa) | 800.21 | 414.85 | 116.39 | 1521.31 |

As can be clearly seen from Table 6 above, and FIGS. 4 and 5, the gum base of the invention has rheological properties similar or superior to those of all other samples tested. These results demonstrate that the gum base of the invention has the ability to resist an applied stress or strain similar to that of Wrigley gum at low amplitudes/stresses and in that a much higher force can be applied before irreversible damage is done to the structure of the sample.

In terms of a chewing gum product this means that the gum base of the invention has initial chewing properties similar or superior to those of other gum products, while requiring a greater input of energy by the consumer to completely destroy the product. The inventors are confident however that any range of textural properties could be created using this technology and novel functional ingredients.

TABLE 7
A comparison of Complex moduli of various gum at 0.01% strain
(inside the linear viscoelastic range).

| | 1 | 2 | 3 | 4 |
|---|---|---|---|---|
| 0.01% strain | 1.02E+04 | 2.15E+03 | 2.52E+03 | 6.42E+06 |

In relation FIG. 6 and Table 7 above, the gum base of the invention has a far greater resistance to deformation (complex modulus) at all applied strains compared to gum bases formed using gluten and water but without the pressure treatment. It is important to note that the final Gum based produced by UCC has a complex modulus of approximately 6,000,000, one thousand times higher than the majority of these samples. It is clear from these results that the gum base produced by UCC has a significantly higher ability to resist an applied force than all samples checked—this shows that the method of production utilised by UCC offers significant advantages over a range of treatments.

### Biodegradability/Digestability

Model evaluation (N=20): In this study it was found that the chewed gum displayed fungal growth and a significant level of breakdown in structure after 4 weeks of storage. It is important to note however in a real life situation the exposure to fungi as well as other microbes and enzymes as well as environmental factors would be much higher and the inventors are confident that the level of breakdown would be significantly higher. On evaluation of the unchewed gum base, no fungal growth or breakdown of the structure was observed after 8 weeks of storage under these conditions.

Environmental evaluation (N=7): On evaluation of the chewed gum base in environmental conditions a significant problem was encountered. This was that birds and wildlife constantly ate the samples left around—this significantly reduced the sample size evaluated (out of 30 samples only 7 remained). These 7 samples however had to be stored in glass containers to stop them being eaten so again actual environmental conditions were not utilised. In all cases a significant level of fungal growth as well as break down of sample was observed after 1 week of storage.

Protease treatment (N=20): In this study the samples were treated and packed as for the model evaluation however before packing the samples were sprayed with 0.1 mL of the protease solution. It was found that within 2 hours of treatment a significant level of breakdown was observed.

Chewing gum use is beset with problems surrounding its damaging impact on the environment and on human health. To combat these issues the current inventors have utilized cereal proteins such as gluten in combination with a processing technique to produce a gum base for use in the preparation of a chewing gum, boasting all of the desired organoleptic and rheological traits, whilst exhibiting none of the unfavorable properties associated with commercially available gum products that have led to a cause for concern. The current inventors have optimized the parameters suitable to modify the viscoelastic and rheological properties of cereal proteins such as gluten, showing that a combination of both high hydrostatic pressure and intermediate temperature together with a functional additive are required to modify gluten properties. As gluten is a common waste product from the production of wheat starch, the chewing gum produced by the method of the current invention is digestible allowing it to be swallowed by the consumer. Importantly, the gum base and/or chewing gum of the current invention is also biodegradable, as well as edible and digestible. An added benefit is that it also comprises cheap, readily available sustainable ingredients. The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

1-34. (canceled)

35. A method for the preparation of a gum base or chewable entity, the method comprising the step of treating a mixture comprising cereal protein and water, optionally in combination with sugar or a sugar substitute, at a hydrostatic pressure of at least 100 MPa for at least 2 minutes.

36. A method as claimed in claim 35 in which the mixture is treated at a temperature of at least 25° C. and a hydrostatic pressure of from 100 Mpa to 1500 MPa.

37. A method as claimed in claim 35 in which the mixture comprises 10-35% cereal protein, 10-35% sugar; and 30-80% water.

38. A method as claimed in claim 35 in which the hydrostatic pressure is from 200 and 700 Mpa.

39. A method as claimed in claim 35 in which the treatment is carried out at a temperature of from 35° C. and 150° C.

40. A method as claimed in claim 35 in which the treatment time is from 2 to 60 minutes.

41. A method as claimed in claim 35 in which the hydrostatic pressure is between 400 and 600 Mpa, the temperature of from 40° C. and 80° C., and the treatment time is from 5 to 15 minutes.

42. A method as claimed in claim 35 in which the mixture comprises 15-25% cereal protein, 15-25% sugar; and 50-70% water.

43. A method as claimed in claim 35 in which the mixture comprises 25% cereal protein, 25% sugar; and 50% water.

44. A method as claimed in claim 35 in which the cereal protein is gluten.

45. A method as claimed in claim 35 in which the sugar is fructose.

46. A method as claimed in claim 35 including a further heating step after the pressure treatment.

47. A gum base or chewable entity obtainable by the method of claim 35.

48. A gum base or chewable entity comprising pressure treated cereal protein and water.

49. A gum base or chewable entity as claimed in claim 48 comprising heat and pressure treated cereal protein.

50. A gum base or chewable entity as claimed in claim 48 in which the cereal protein is gluten.

51. A gum base or chewable entity as claimed in claim 48 further including a sugar or sugar substitute.

52. A gum base or chewable entity as claimed in claim 48 and having a break point of at least 600 Pa.

53. A gum base or chewable entity as claimed in claim 48 and having a complex modulus at 0.01% strain of at least 100,000 Pa.

54. A gum base or chewable entity as claimed in claim 48, further comprising sugar or sugar substitute, having a break point of at least 600 Pa, and being biodegradable and digestible.

55. A gum base or chewable entity as claimed in claim 50, further comprising sugar, having a break point of at least 600 Pa, and being biodegradable and digestible.
